(19) United States
(12) Patent Application Publication
(10) Pub. No.: US 2024/0308182 A1
(43) Pub. Date: Sep. 19, 2024

(54) THIN, FLEXIBLE, TUNABLE INFRARED EMISSIVITY BASED ON CARBON NANOTUBES

(71) Applicant: Battelle Memorial Institute, Columbus, OH (US)

(72) Inventors: Amy M. Heintz, Dublin, OH (US); Katherine M. Palmer, Galloway, OH (US); Krenar Shqau, Columbus, OH (US); Philip P. Cheney, Columbus, OH (US)

(21) Appl. No.: 18/577,976

(22) PCT Filed: Jul. 14, 2022
(86) PCT No.: PCT/US2022/037224

§ 371 Date: Jan. 9, 2024

Related U.S. Application Data
(60) Provisional application No. 63/221,914, filed on Jul. 14, 2021.

(51) Int. Cl. B32B 15/14; B32B 5/02; B32B 15/20; B32B 27/12

(52) U.S. Cl. CPC B32B 15/14; B32B 5/022; B32B 5/024; B32B 15/20; B32B 27/12; B32B 2255/02; B32B 2255/10; B32B 2255/20; B32B 2255/205; B32B 2260/021; B32B 2262/0253; B32B 2457/20

(57) ABSTRACT

A thermal management or infrared display system comprises: a first electrode, a storage layer comprising a dopant, a CNT layer in contact with the storage layer, and a second electrode. Applying a voltage between the electrodes changes the infrared emissivity such that the apparent temperature of the surface changes. In this fashion, the infrared emissivity of a substrate can be tuned.

### RELATED APPLICATIONS

This application claims the benefit of U.S. Provisional Patent Application Ser. No. 63/221,914 filed 14 Jul. 2022.

### INTRODUCTION

A review of tunable emissive materials is described by Lang et al. “Review of Variable Emissivity Materials and Devices Based on Smart Chromism,” Int. J. Thermophys. (2018). General descriptions of devices having a surface with tunable emissivity are shown in U.S. Pat. Nos. 8,784,151 and 9,487,311. Xiao et al. in “Fast Adaptive Thermal Camouflage Based on Flexible VO2/Graphene/CNT Thin Films” describe a variable emissivity thin film of VO₂ coated on a graphene/CNT thin film.

The invention includes a layer of carbon nanotubes (CNTs). Methods of making CNT layers are described in U.S. Pat. Nos. 9,365,728; 10,059,848; 10,144,638; 10,226,789; 10,358,562; and 10,570,293 which are incorporated herein as if reproduced in full.

### SUMMARY OF THE INVENTION

Emissivity, especially in the infrared spectrum, is an important property for controlling the thermal radiative properties of materials. It is this radiation that is used to determine the temperature of objects by thermal imaging camera. This invention is concerned with dynamic control over the emissivity in the infrared range.

In a first aspect, the invention provides a thermal management system or infrared display system comprising a device comprising, in sequence: a first electrode, a storage layer comprising a dopant, a CNT layer in contact with the storage layer; and a second electrode, wherein the storage layer comprises a woven or nonwoven fabric, porous ceramic, or gel.

In a second aspect, the invention provides a thermal management or infrared display system comprising a device comprising, in sequence: a first electrode, a storage layer comprising a dopant, a CNT layer in contact with the storage layer; and a second electrode, wherein the CNT layer has two opposing, major surfaces wherein one major surface contacts the storage layer and the other major surface contacts the second electrode.

In another aspect, the invention provides a method of providing adaptive thermal management on a surface of a substrate, comprising: providing a system comprising: the substrate; a storage layer comprising a dopant disposed on the substrate, a CNT layer in contact with the storage layer; a first electrode, and a second electrode; the electrodes contact the storage layer and/or CNT layer; and applying a voltage to the electrodes that causes the mobile dopant to modify the emissivity of the CNT layer. In various embodiments, methods of the invention also include any of the device features described herein.

In preferred embodiments, the substrate is at a temperature of at least 60° C., or at least 65° C., or at least 80° C., (or the device is held at 60° C., or 65° C., or 80° C.) and wherein the invention lowers the apparent surface temperature by at least 10° C., or at least 20° C. (or in the range of 10 to 40° C. or 10 to 30° C.) relative to the untreated surface when a voltage of at least 1 V or at least 3 V or at least 5 V (or exactly 1 V or 3 V or 5 V) is applied between the electrodes. Temperature of the surface can measured by conventional means such as the FLIR systems mentioned herein.

Any of the inventive aspects may include a plurality of cells that can be independently addressed so that different voltages are applied to different areas of a surface leading to different apparent surface temperatures corresponding to the different voltages.

The invention includes any of the devices, components or methods described herein. The electrodes can be connected to two bus bars, by which voltage is applied. The invention also includes methods of changing the infrared emissivity by applying a voltage to the device. This is useful for dynamic thermal control and for modifying the infrared spectral properties, such as to create an infrared beacon or infrared display. To provide the infrared change or display function, the CNT is disposed near an exterior surface so that infrared radiation emitted, reflected, or transmitted from or through the CNT layer can exit the device; therefore, it is preferred that a CNT layer is oriented so that a major surface (to define a major surface, layers are viewed as cubes or more typically rectangular prisms that have two major surfaces) is separated from the environment by a protective layer and/or electrode which (combined in the case of both an electrode and protective layer) absorbs no more than 20%, more preferably 10% or less, and still more preferably 5% or less of the near infrared integrated intensity; preferably this is from 20 to 150° C. In preferred embodiments, the CNT layer is within 20 nm or within 10 nm of the environment (in other words, the CNT layer or a thin protective layer is on the exterior of the device).

The invention also includes methods of making the thermal management or infrared display system using any of the methods mentioned herein. For example, in an inventive aspect the invention provides a method of making a system comprising: positioning the storage layer and adjacent CNT layer (for example by coating the storage layer with a dispersion of CNTs) and contacting the CNT layer with electrodes. The storage layer can be positioned (or disposed onto) a conductive ground plane which is electrically connected to an electric lead. The invention also includes intermediates formed in the manufacture of the device (the composition of these intermediates is apparent from the descriptions herein).

The storage layer contains a reservoir of dopant so that, under the influence of an electric field, dopant can migrate into the CNTs and/or facilitate charge transfer. When the field is reversed, dopant may migrate into the storage (storage) layer and/or facilitate charge transfer in a reverse direction. It is therefore understood that “storage” means that the layer can store the dopant and/or allow for dopant mobility. For example, it can comprise a fabric, high surface area materials, or chemically or physically crosslinked gel.

The device can be applied to substrates such as clothing or a vehicle such as an aircraft, personnel carrier, truck, tank, or naval vessel. The device can be a display device with the infrared radiation emitted in a desired pattern. Voltage can be applied in different increments to change the infrared emissivity in different increments, from 0.1 to 0.9 in the region from approximately 5 to 12 microns. A plurality of cells can be connected to an electrical circuit so that each cell can be independently addressed. As with any device or composition, the invention can be defined in terms of its measurable properties, in the case of the present invention measurable properties such as transmission and infrared (thermal) emission as a function of temperature in response to an applied voltage.

The invention also may include any of the devices, composites and methods of making as described above, or in the detailed description below. The invention includes methods of modifying the emissivity of the surface of an article and articles comprising the composite structures described herein. The invention is intended, in its various embodiments, to include combinations of any of the features described herein. The invention includes any of the components described in this application and/or the incorporated patents, and in any combination of features. The descriptions are not intended to be limited to particular embodiments but, in broader aspects of the invention, the features described are intended to be applicable to any of the inventive aspects.

The present invention can provide a capacitor cell type that includes a CNT cathode capable of changing its NIR emission when exposed to an electric field. This change in NIR emission is due to interaction of the CNTs with anionic species containing an isolated electron pair. The amount of electron transfer can be tailored by the strength of applied electrical field that would determine the doping level or the Fermi level shift of the CNTs.

Two examples of the anionic species include the bis(trifluoromethylsulfonyl)imide or/and dicyanamide ions listed below:

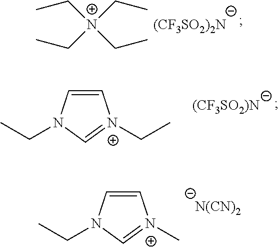

Ionic Liquids (iLs) are very stable or have a large reduction/decomposition potentials (Electrical Working Windows is around or above 5V), therefore they can change CNTs Fermi energy due to the intercalation that becomes pronounced at or above about 3 volts.

The devices and methods of the present invention can provide advantages such as improved tunability of infrared emissivity and superior stability.

### Glossary

The term “carbon nanotube” or “CNT” includes single, double and multiwall carbon nanotubes and, unless further specified, also includes bundles and other morphologies. The invention is not limited to specific types of CNTs. The CNTs can be any combination of these materials, for example, a CNT composition may include a mixture of single and multiwall CNTs, or it may consist essentially of DWNT and/or MWNT, or it may consist essentially of SWNT, etc. CNTs have an aspect ratio (length to diameter) of at least 50, preferably at least 100, and typically more than 1000. In some embodiments, a CNT network layer is continuous over a substrate; in some other embodiments, it is formed of rows of CNT networks separated by rows of polymer (such as CNTs deposited in a grooved polymer substrate). The CNTs may be made by methods known in the art such as arc discharge, CVD, laser ablation, or HiPco. The G/D ratio of CNTs is a well-known method for characterizing the quality of CNTs.

Upon applying a voltage, e.g., going from p-doping to n-doping, the change near the far-infrared is relatively CNT-independent and relates to changes in the Fermi level. There is also a change from the visible to NIR (e.g., approximately 500 nm to 2000 nm) if semiconducting CNTs are present, as in single wall carbon nanotubes. Therefore, this property can be determined by appropriate materials selection and, as described below using the Kataura plot.

The optical absorbance spectrum of CNTs can be characterized by S22 and S11 transitions, whose positions depend upon the structure distribution of the CNTs and can be determined by a Kataura plot. These two absorption bands are associated with electron transitions between pairs of van Hove singularities in semiconducting CNTs.

Carbon nanotubes can be defined by purity factors that include percentage of metallic impurities (usually catalytic residues such as Fe, Mo, Co, Mn, etc,) and percentage of non-carbon nanotube impurities, which can be characterized by methods known in the art such as thermogravimetic analysis. The chemistry of the impurities can be determined by methods such as SEM-EDS. It is preferable to use carbon materials that have high purity, as these often have better combination of high conductivity and corrosion stability. Less than 1 to 2 mass % metallic impurities are preferred.

“Glycosaminoglycans” are long unbranched polysaccharides consisting of a repeating disaccharide unit. The repeating unit (except for keratan) consists of an amino sugar (N-acetylglucosamine or N-acetylgalactosamine) along with a uronic sugar(glucuronic acid or iduronic acid) or galactose. Glycosaminoglycans are highly polar. Anionic glycosaminoglycans are characterized by having at some hydroxyl protons replaced by a counter ion; typically an alkali or alkaline earth element. Examples of glycosaminoglycans include: β-D-glucuronic acid, 2-O-sulfo-β-D-glucuronic acid, α-L-iduronic acid, 2-O-sulfo-α-L-iduronic acid, β-D-galactose, 6-O-sulfo-β-D-galactose, β-D-N-acetylgalactosamine, β-D-N-acetylgalactosamine-4-O-sulfate, β-D-N-acetylgalactosamine-6-O-sulfate, β-D-N-acetylgalactosamine-4-O, 6-O-sulfate, α-D-N-acetylglucosamine, α-D-N-sulfoglucosamine, and α-D-N-sulfoglucosamine-6-O-sulfate.

Near Infrared Radiation (NIR) is light having wavelengths in the range from 800 nm to 2500 nm.

“Polysaccharides” are polymeric carbohydrate molecules composed of long chains of monosaccharide units bound together by glycosidic linkages and on hydrolysis give the constituent monosaccharides or oligosaccharides. Anionic polysaccharides are characterized by having at least some hydroxyl protons (the most labile hydroxyl protons are associated with carboxylic acid moieties) replaced by a counter ion; typically an alkali or alkaline earth element. Examples of anionic polysaccharides include natively anionic polysaccharide gums and natively non- or cationic polysaccharide gums being chemically modified to have an anionic net charge. Polysaccharide gums contemplated for use in the present invention include Agar, Alginic acid, Beta-glucan, Carrageenan, Chicle gum, Dammar gum, Gellan gum, Glucomannan, Guar gum, Gum arabic, Gum ghatti, Gum tragacanth, Karaya gum, Locust bean gum, Mastic gum, Psyllium seed husks, Sodium alginate, Spruce gum, Tara gum and Xanthan gum, the polysaccharide gums being chemically modified, if necessary, to have an anionic net charge.

The invention is often characterized by the term “comprising” which means “including.” In narrower aspects, the term “comprising” may be replaced by the more restrictive terms “consisting essentially of” or “consisting of.”

### BRIEF DESCRIPTION OF THE DRAWINGS

FIG. 1A schematically illustrates a cross section of a structure of the invention.

FIG. 1B schematically illustrates a structure of the invention comprising a ground plane, layer containing ionic liquid, and top CNT layer.

FIG. 1C shows IR emission and thermal images of devices exposed at different applied current across the CNT layer. The Y-axis is emission intensity and the X-axis is wavenumber in cm⁻¹. Images in the inset are black and white renditions of color photos of test samples.

FIG. 2 illustrates the cross section of a structure having a grooved substrate (with the triangular cross-sections), A CNT composition in the grooves, and a protective film disposed over the CNT-filled substrate.

FIG. 3 is an overhead view of the structure of FIG. 2 showing electrical leads disposed to provide an electrical connection to the CNT composition in the grooves.

FIG. 4 illustrates an array of 6 panels which can be individually addressed to make a pattern of various IR emissivity even where the panels are at the same temperature.

FIGS. 5-7 schematically illustrate CNT panels and electrical connections for addressing individual locations within a CNT-covered substrate.

FIG. 8 shows photographs of the systems prepared in Example 2. As can be seen in the right of the figure, the apparent temperature, as measured by thermal imaging, varied depending on the applied voltage, while the four samples were maintained at the same actual temperature of 123° F.

FIG. 9 is a plot of active and apparent temperatures from three different test conditions.

### DETAILED DESCRIPTION OF THE INVENTION

### Construction of Devices

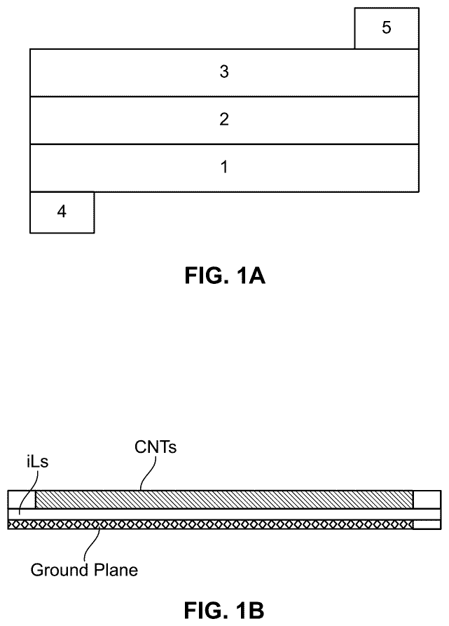

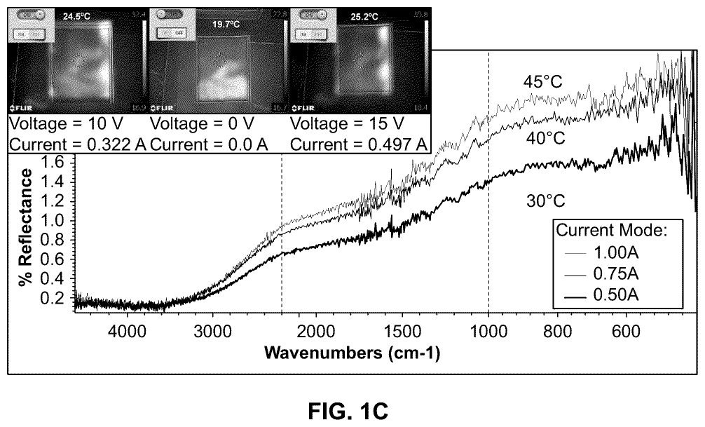

FIG. 1A shows an intermediate structure. The first layer (1) is a conductive electrode. It is in direct contact with a storage layer containing a dopant (2). This is in contact with the top layer (3) a CNT electrode. The structures (4) and (5) are busbars that are used to apply voltage across the electrode. In a preferred configuration, the conductive layer is a thin layer of aluminum, which is applied to a flexible substrate and the flexible substrate is the storage layer, such as porous polyethylene, which can be filled with a dopant. In other configurations, the layer (1) can be applied to a structural substrate and the storage layer can be applied on top of the metal electrode. The busbars (4) and (5) can be a single material or they can be a conductive material (such as Cu bars or wires 5) attached to the layers (1) and (3), respectively, by adhesive with conductive filler and forming sloped sides. When current is applied across this sandwich, charge transfer doping occurs in the CNT layer.

In another embodiment (not pictured), the CNT layer extends only partway between the electrodes (or is in the form of multiple strips that run parallel to the electrodes) and a storage layer (or a storage material (layer) in strips alternating with the CNT strips) contact the CNT layer so that electric current flows from one electrode to the other electrode through both the storage layer and the CNT layer.

FIG. 1B illustrates an alternative design having busbars 1, 2 in the plane of the top CNT layer and adapted to pass current through the top CNT layer. This current causes an increase in temperature and changes the IR emission as shown in FIG. 1C. In addition, the other busbars 1, 3 can be used to apply voltage across the dopant layer causing a decay in IR emission. For example, for a CNT layer that exhibited an apparent temperature of 61° C. at 0 volts (no potential between electrodes 1 and 3) and an apparent temperature of 48° C. at 5 volts. A conductive ground plane layer comprises a material which could comprise a metal such as aluminum, or in preferred embodiments, a CNT layer. A porous layer comprising an ionic liquid (iLs) is disposed between the conductive ground plane and the top CNT layer. The ground plane could comprise a porous substrate such as porous Tyvek or a ceramic substrate such as alumina or zirconia. In some embodiments, the conductive ground plane and the top CNT layer are on opposite sides of the porous layer comprising an ionic liquid.

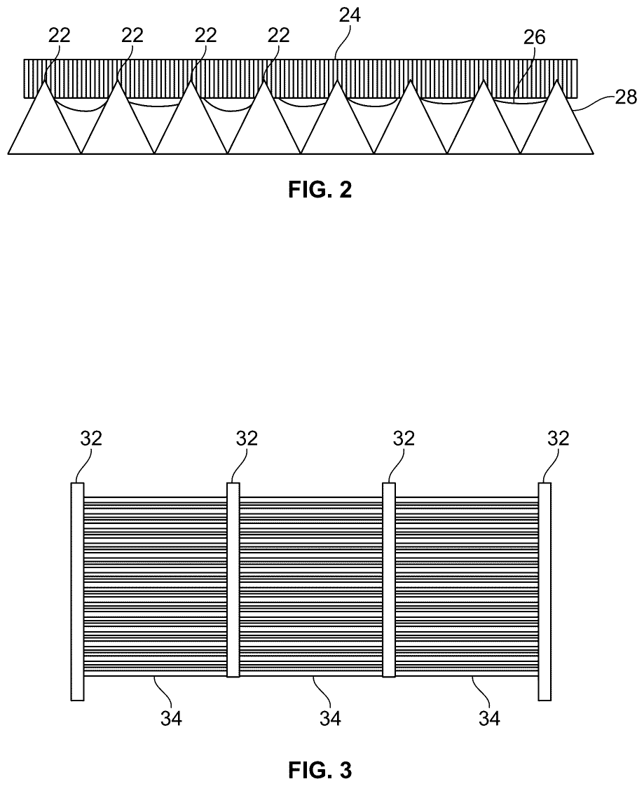

FIGS. 2 and 3 show a configuration with a CNT layer disposed in grooves with electrical leads 32 disposed perpendicular to the grooves. A storage layer can be disposed in the grooves below the CNT layer 26 or intermittently within each groove so that the CNT layer is not continuous in each groove so that current passes through both storage layer and CNTs. A protective layer 24 is disposed over the tips 22 of the groove sides 28 of the device 34.

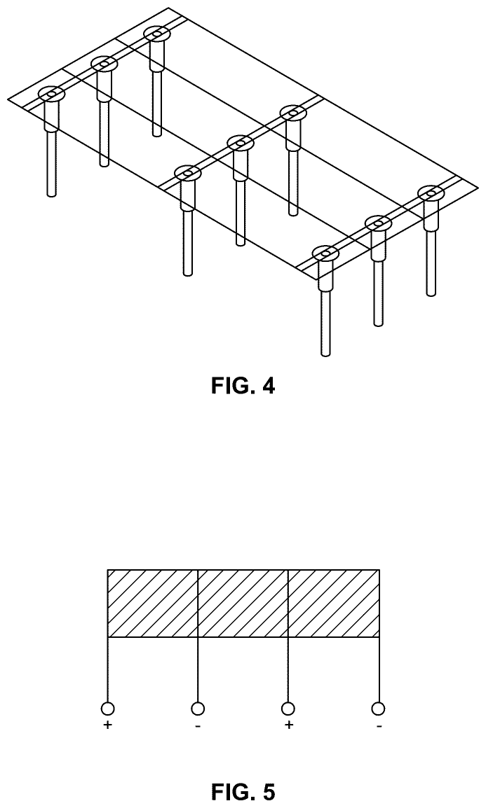

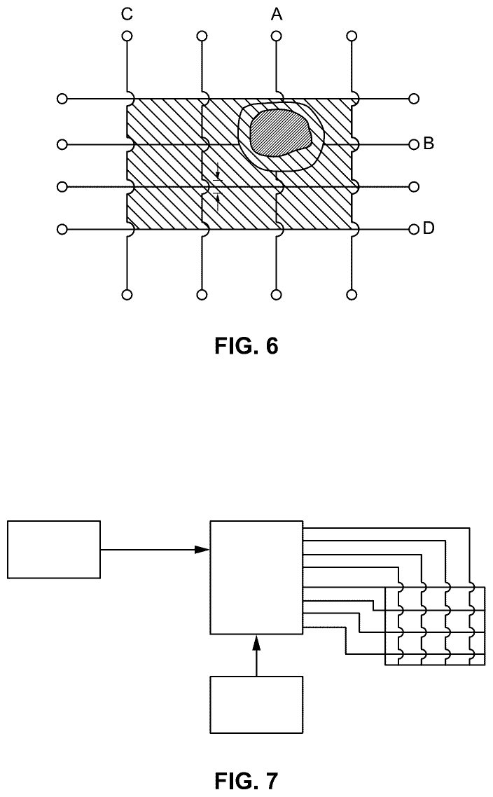

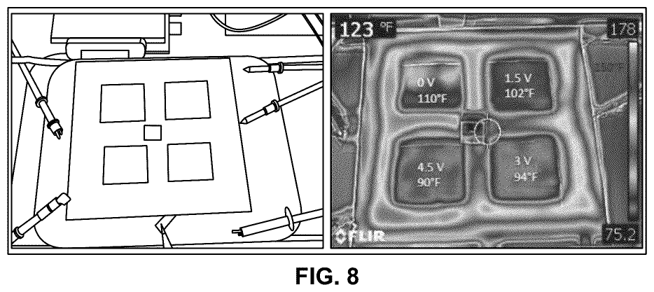

FIG. 4 shows an assembly 196 comprising an array of panels 198 and three conductive strips with nine conducting pins. FIGS. 5-7 show a circuit that can be used to control emissivity in selectively addressable areas.

The “bottom” electrodes (such as 1 in FIG. 1A) are typically metallic but can be any conductive material. The electrodes are preferably planar and preferably have areas that are approximately the same area (within about 10%) as the area of the top CNT layer. In some embodiments, the top busbar (5) is positioned on the side of the CNT layer on the surface of the device (i.e., the intended emitting surface). Application of voltage changes the emissivity of the underlying CNT layer by at least 20% or at least 10% or at least 5%. The bottom electrode(s) may include polymeric films coated (typically by sputtering) with a thin film of conductive material such as aluminum.

In other embodiments, the second electrode is oriented on a side of the CNT layer so that emissions from the surface of the CNT layer (into the environment or in the direction of an observer) do not (or chiefly do not, or substantially do not) pass through an electrode. Optionally, the CNT layer may be coated with a thin protective layer; if a protective layer is used, it is preferably a low emissivity material. For purposes of the present invention, emissivity refers to the infrared spectrum as can be measured with common thermal imagers. Experimental emissivity and apparent temperature were measured with a FLIR C3, FLIR C3-X, or FLIR T420 thermal imaging camera. In some embodiments of the present invention, the CNT layer is the outermost layer of the device (i.e., the CNT layer is exposed to the environment).

### Dispersions of CNTs

CNT networks may be fabricated by depositing a CNT-based dispersion, paint, or ink onto a substrate, using liquid deposition processes such as aerosol spraying, slot coating, inkjet printing, and gravure printing. Useful dispersions must have the appropriate viscosity and surface energy to coat the substrate, as well as sufficiently high loading of CNTs to allow formation of highly conductive films in few coating passes. Aqueous-based dispersions are preferred for must applications due to their low VOCs and compatibility with a variety of substrates. A dispersing agent or surfactant is needed to disperse the CNTs into water. Common dispersing agents and surfactants are water soluble and have a charged moiety or other chemical group that can interact with the CNTs. Upon deposition of the dispersion, the CNTs and dispersing agents or other additives dry to form a film.

The CNTs are typically inert to moisture. However, the presence of the dispersing agent in the film contributes to moisture sensitivity in the film. Moisture sensitivity can lead to changes in conductivity or to loss of mechanical and adhesive integrity during moisture exposure, humidity exposure, and subsequent coating steps.

Surfactants could include typical anionic, cationic, and non-ionic surfactants known in the art to stabilize CNTs. Dispersing agents could include molecules and polymers that stabilize CNTs by steric stabilization, such as alkylamines, or by non-covalent modification, such as pyrenes and naphthalene sulfonic acids.

The electrical properties of CNTs are very sensitive to the environment. One common way to prepare CNT materials is to employ acid oxidation methods to improve their dispersibility in water and solvents. After deposition and drying, these CNTs remain p-doped. The electrical resistance of such films is susceptible to electron donating solvents such as those typically used in commercial aerospace topcoat coatings. Electron donating solvents include common solvents such as water, diethyl ether, tetrahydrofuran, dimethylformamide, N-methylpyrrolidinone, ethanol, methanol, isopropanol. Other common ways to prepare CNT materials include the use of dispersing agents. These systems are generally un-doped systems, or un-intentionally p-doped by adventitious dopants such as oxygen. The resistance of these systems also increases upon exposure to water and other electron-donating solvents. Finally, CNT materials are sometimes formulated with a second material that behaves as an intentional p-dopant. Treatment with water or solvents can remove or dilute the effect of the p-dopant on the CNT material; thereby increasing its resistance.

A dispersion can be prepared by providing a dispersion comprising CNTs and an anionic glycosaminoglycan or an anionic polysaccharide; depositing a dispersion onto a surface to form a film; wherein the film comprises the CNTs and the anionic glycosaminoglycan or anionic polysaccharide; and washing the film with an aqueous acidic solution having a pH between 0 and 4. The anionic glycosaminoglycan or polysaccharide contains cations that are at least partly removed by the acid wash and replaced by protons; thus, when a glycosaminoglycan or polysaccharide is used as the dispersant, converting the glycosaminoglycan or polysaccharide to the nonionic or, more nearly nonionic form. The cations typically comprise Na, K, Ca, or Mg; preferably Na or K, most preferably Na.

In some preferred embodiments, carbon nanotubes (CNT) films prepared from aqueous paints can be stabilized against moisture damage by using hyaluronic acid (HA), sodium salt as the dispersing agent and performing a mild acid wash (pH˜2.5) after film deposition. The mild acid wash changes the surface energy of the film and the solubility behavior of the film. After treatment, the film does not blister after longer term exposure to humidity. It is more readily wetted and coated by paints or other organics. The treatment does not remove the HA; thus the material can be reacted with a variety of reagents, such as electrophiles like isocyanates and isobutylene, creating hydrophobic and/or crosslinked films. Other anionic glycosaminoglycan or anionic polysaccharides could be used according to the methods of the present invention, although, in some embodiments, HA is the most preferred.

Sodium hyaluronate is the sodium salt of hyaluronic acid (HA). Hyaluron is a viscoelastic, anionic, nonsulfated glycosaminoglycan polymer. It is found naturally in connective, epithelial, and neural tissues. Its chemical structure and high molecular weight make it a good dispersing agent and film former. CNT/HA aqueous dispersion and phase diagram has been reported in the literature (Moulton et al. J. Am. Chem. Soc. 2007, 129(30), 9452). These dispersions may be used to create conductive films by casting the solution onto a substrate and allowing it to dry. However, the resulting films exhibit blistering, i.e. loss of adhesion, upon exposure to moisture or high humidity. In addition, they suffer from resistance fluctuations that occur as a result of moisture fluctuations, as HA can expand and contract, changing the junction resistance between CNT-CNT contacts. Likewise is true for many common dispersing agents.

The stability of these CNT film can be substantially improved by treatment with a mild acid solution, preferably using an acid having a pKa less than about 4.8, more preferably less than 3.2. The pH of the treatment solution is preferably in the range of 1 to 2.5. More acidic solutions can be effective at stabilizing the film. However, care must be taken not to react with any other materials, such as the dopant-containing storage layer. The acid solutions are preferably non-oxidizing; in other words, it preferably does not contain oxidizing acids such as nitric acid that react with the CNTs. The stability is provided by a decrease in the sensitivity of the dispersing to moisture. Reaction of the anionic dispersing agent with phosphoric acid provides a structure that is substantially free of carboxylates, and associated counterions such as Na, K, etc. This acidified polymeric compound has a different surface energy, facilitated by change in conformation, and swells less than parent dispersing agent. This behavior, in turn, stabilizes the distance between CNT-CNT junctions, thereby stabilizing the resistance.

The CNT compositions have the added advantage that they may be readily reacted with hydrophobic reactants, such as alkyl and aryl isocyanates and diisocyanates, diazomethane, isobutylene and other 1,1-disubstituted alkenes, acid chlorides and diacid chlorides, and anhydrides, providing highly conductive, mechanically robust films.

The CNT layer can be formed from a dispersion that can be additionally characterized by one or any combination of the following features: wherein the majority by the mass of the CNTs are single-walled CNTs; wherein the dispersion comprises CNTs and a glycosaminoglycan; wherein the dispersion comprises CNTs and HA; wherein the dispersion comprises between 30 and 60 wt % CNTs; wherein the dispersion comprises between 30 and 70 wt % glycosaminoglycans and polysaccharides; wherein the sum of all cations associated with the glycosaminoglycan or polysaccharide make up less than 1 wt %, preferably less than 0.5 wt % of the dispersion; wherein the sum of Na, K, Mg, and Ca associated with the glycosaminoglycan or polysaccharide is 0.5 wt % or less, or 0.2 wt % or less of the dispersion; a resistance of 0.5 to 5 Ω/square or a conductivity of 1000 to 6000 S/cm wherein the volume average size CNT particles, as observable by SEM, of 1 μm or less, where size is the largest dimension observed in the SEM; wherein the mass average molecular weight of the glycosaminoglycan or polysaccharide is in the range of 1000 to 100,000, or in the range of 5,000 to 50,000; wherein the CNTs in the dispersion have a Raman G/D of 12 to 17; wherein the CNT layer, without a topcoat (meaning either prior to applying a topcoat or removing any topcoats for testing purposes), possesses moisture resistance such that, if the CNT layer is coated with a polyurethane topcoat that is about 1 mil (0.025 mm) thick and exposed to a relative humidity of 40% at 60° C. for 60 hours and the resistance of the CNT layer is measured at the times of 30 to 60 hours of the exposure, the resistance of the CNT layer preferably increases by no more than 1%, more preferably no more than 0.5% and in some embodiments 0.0 to 0.5%; wherein the CNT layer, without a topcoat, possesses moisture resistance such that, if heated to 120° C. for 2 hours and cooled to room temperature for 10 minutes, the resistance of the CNT dispersion increases by less than 200%, preferably less than 100%, in some embodiments between about 70 and 200%.

A CNT network can be prepared, for example, as a dispersion of CNTs applied directly to a substrate where the solvents used in the dispersion process are evaporated off leaving a layer of CNTs that coagulate together into a continuous network. The CNT network may be prepared from dispersions and applied by coating methods known in the art, such as, but not limited to, spraying (air assisted airless, airless or air), roll-coating, gravure printing, flexography, brush applied and spin-coating. The thickness of the CNT layer is preferably in the range from 0.005 μm to 100 μm, more preferably in the range of 0.05 μm to 100 μm, and in some embodiments in the range of 0.3 μm to 20 μm.

A CNT layer is defined as a solid CNT composition, such as a CNT network; in some embodiments it is not a dispersion of CNTs in a polymer matrix. In some embodiments, a cross-sectional view of the composite material will show a polymer layer that contains little or preferably no CNTs and a CNT network layer that comprises CNTs (and possibly other carbonaceous materials that commonly accompany CNTs) with little or no polymer. CNT networks and CNT fibers have very distinct rope-like morphology as observed by high resolution SEM or TEM. See for example Hu, L.; Hecht, D.S.; and Gruner, G. Nano Lett., 4 (12), 2513 -2517 for CNT networks and U.S. Pat. No. 6,683,783 for images of CNT fibers. Because the CNT layers contain little or no polymer, they exhibit surface roughness, if characterized by AFM, associated with the CNT diameter and bundle size, in the range of 0.5 to 50 nm. CNT network layers have many contacts between CNTs and good conductivity that is, a resistivity less than 0.02 Ω·cm, preferably less than 0.002 Ω·cm. The CNT layer may be planar, cylindrical, or other contiguous geometry; in some preferred embodiments, the CNT layer is substantially planar (similar to a sheet of paper or a nonwoven textile sheet, a few fibers may project from a planar layer).

In some embodiments, the CNT layer is substantially polymer-free such that polymer (if present) does not significantly affect the electrical properties of the layer; preferably, the interior of the CNT layer contains 10 weight % polymer or less, more preferably 5 weight % or less, and still more preferably 2 weight % or less.

In some preferred embodiments of the invention, the composite comprises a planar surface. In some preferred embodiments, the CNTs are in the form of a substantially planar layer. The CNT films preferably have low sheet resistance, where low resistance is defined as less than 100 Ω/square, or in the range of 0.5 to 100 Ω/square, in some embodiments in the range of 0.5 to 3 Ω/square. The resistance of CNT films depends on the thickness of the film and the bulk conductivity of the film, which is a function of the solid loading of CNTs in the film, the dispersion quality, and the quality of the CNTs. The bulk conductivity of films is preferably in the range of 1500 to 6000 S/cm or 2000 to 6000 S/cm, more preferably in the range of 3000 to 6000 S/cm. The bulk conductivity can be determined by measuring the sheet resistance (Ω/square) and the thickness of the CNT film. The bulk conductivity is the inverse of the bulk resistivity, which is determined as the sheet resistance * thickness). The CNT layer may be planar, cylindrical, or other contiguous geometry; in some preferred embodiments, the CNT layer is substantially planar (similar to a sheet of paper or a nonwoven textile sheet, a few fibers may project from a planar layer). The characteristics of the CNT layer may be either or both before and after a coating is applied over the CNT layer.

The sheet resistance of the CNT layer before coating may be determined by standard 4-point probe methods or other known methods for determining sheet resistance. The impact of the subsequent coatings on the sheet resistance of the underlying material may be determined by one of several methods, depending on the applications of interest. Metallic leads, such as silver painted leads, may be applied under or over the CNT layer. An overcoat can be removed and the resistance of the CNT layer measured by a 4-point probe. The thickness of this layer can be determined by potting the material in epoxy, sectioning to create a cross section, and the measurement of the thickness by optical microscopy or scanning electron microscopy. The thickness and sheet resistance are used to calculate the bulk conductivity.

Prior to an optional step of coating with a polymer or polymer precursor composition (to form the protective coating), a CNT network layer is preferably in the form of a CNT/air composite, for example a CNT network film, a paper or cloth-like layer of CNTs, or a macroscopic fiber of CNTs. CNT network layers of the present invention preferably contain at least 25 weight % CNT, in some embodiments at least 50 weight %, and in some embodiments 25 to 100 weight % CNT. The CNTs can be distinguished from other carbonaceous impurities using methods known to those skilled in the art, including NIR spectroscopy (“Purity Evaluation of As-Prepared Single-Walled Carbon Nanotube Soot by Use of Solution-Phase Near-IR Spectroscopy,” M. E. Itkis, D. E. Perea, S. Niyogi, S. M. Rickard, M. A. Hamon, H. Hu, B. Zhao, and R. C. Haddon, Nano Lett. 2003, 3(3), 309) Raman, thermogravimetric analysis, or electron microscopy (Measurement Issues in Single Wall Carbon Nanotubes. NIST Special Publication 960-19).

In some preferred embodiments, the CNT network layer (prior to application of a coating) preferably has little or no polymer (“polymer” does not include CNTs or carbonaceous materials that typically accompany CNTs-typical examples of polymers include polyurethane, polycarbonate, polyethylene, etc.); preferably the network layer comprises less than 5 weight % polymer, more preferably less than 1 weight %) The volume fraction in the network layer is preferably at least 2% CNTs, more preferably at least 5%, and in some embodiments 2 to about 90%. The remainder of the composite may comprise air (by volume) and/or other materials such as residual surfactant, carbonaceous materials, or dispersing agent (by weight and/or volume). “Substantially without polymer” means 5 weight % or less of polymer in the interior of a CNT film, preferably the film has 2 weight % or less of polymer, and still more preferably 1 weight % or less of polymer in the interior of the CNT film; which is quite different from composite materials in which CNTs are dispersed in a polymer matrix.

### Storage Layer

The storage layer may comprise an electrolyte with a dopant that can migrate toward the CNT solid surface. The storage layer may comprise a fabric, in some embodiments a polyethylene fabric. The storage layer may comprise a polymeric foam or a polymer, or any material in which the dopant can be stored and respond to an electric field. The storage layer may comprise a porous ceramic (such as alumina, zirconia, ceria, etc.), or storage composite. In some embodiments, the storage layer (prior to adding dopant) has at least 1 vol % or at least 3 vol % or at least 10 vol % porosity as measured by mercury porosimetry. In the present invention, the storage layer contains sufficient dopant such that the emissivity of the adjacent CNT layer changes in the presence of an electric field, preferably varies by at least 5%. In view of the discussion here, a wide range of suitable combinations of storage layers and dopants can be identified with no more than routine experimentation.

In some embodiments, the dopant facilitates charge migration toward or away from the CNT solid surface in response to an electric field. In some embodiments, the dopant intercalates into the CNT layer to change the emissivity of the CNT layer. The porous layer can be a gel, meaning a physically or chemically crosslinked polymer that is swelled by the electrolyte. Preferably, the dopant is an ionic liquid. In the present invention, preferred dopants are ionic materials that are known to dope CNTs to increase conductivity. To achieve an enhancement in conductivity of a CNT polymer composite, a dopant or dopant moiety can be combined with a polymer system. The polymer can serve as a reservoir for the dopant, increasing its stability and improving its interaction with CNTs.

Appropriate porous matrices (layers) depend on the dopant and the end use application. The enhancement effect is facilitated by providing favorable interactions between the dopant and the polymer, as well as the formation of locally inhomogeneous states. Suitable polymers include (but are not limited to) typical barrier polymers such as copolymers of polymethacrylonitrile, polyacrylonitrile, polymethylmethacrylate, or polyvinylidine chloride or copolymer of ethylene and norbornene, as well as polymers such as polysulfones, polyacrylonitrile (PAN), styreneacrylonitrile (SAN), polystyrene (PS), phenolic resins, phenol formaldehyde resin, polyacenaphthalene, polyacrylether, polyvinylchloride (PVC), polyvinylalcohol (PVA), polyvinylidene chloride, poly(p-phenylene terephthalamide), poly-L-lactide, polyimides, polyacrylonitrile copolymers, such as poly(acrylonitrile-methyl acrylate), poly(acrylonitrile-methyl methacrylate), poly(acrylonitrile-itaconic acid-methyl acrylate), poly(acrylonitrile-vinyl pyridine), poly(acrylonitrile-vinyl chloride) and poly(acrylonitrile-vinyl acetate), polypropylene, polyester resins, acrylic resins, epoxy resins, poly(ethylene terephthale), poly(butylene terephthalate), poly(methyl methacrylate), polycarbonate, poly(ether ether ketone), polyvinylidene chloride copolymers, polymethacrylonitrile vinylidenechloride methylacrylate terpolymers, cyclic olefin copolymers, styrene ethylene butylene styrene copolymers, polycarbonate, polyesters, polysulfones, acrylics, poly(tetrafluoroethylene), poly(perfluoroalkyl methacrylate), poly(perfluoralkyl acrylate), and mixtures thereof. Mixtures thereof includes, in various embodiments, all of the combinations/permutations of the above listed polymers.

It may also be desirable for the porous matrix to have additional properties such as high transparency, good abrasion resistance, good adhesion, low refractive index, or high barrier properties to materials such as water or oxygen.

The dopant-filled (also called dopant-containing) polymer may be applied to CNT structures. A layer of the dopant-filled polymer formulation may be formed on or applied to a CNT film, composite, fiber, or collection of fibers. The CNT top layer is in direct contact with the dopant-containing porous matrix.

The porous storage layer thickness is desirably chosen to maximize its sequestering effect on the charge transfer agent but minimize its insulating effect. In some embodiments, the thickness of a storage layer is 1000 nm or less, preferably 500 nm or less, in some embodiments 400 nm or less, and in some embodiments the thickness of the storage layer is between 15 and 500 nm.

In some preferred embodiments, the dopant-containing storage coating in contact with a CNT coating simultaneously decreases the sheet resistance of the CNT layer and facilitates charge transfer through the storage layer. Charge transport through the storage layer is strongly dependent on the distance between localized states, the extension of the localized states, and the redox characteristics of these states. The dopant moieties within the storage layer facilitate the formation of localized states. Copolymers or polymers having large heterogeneity between the backbone and the sidechain are preferred. By controlling the phase behavior of the formulation, e.g., through increasing the relative volume fraction of dopant, copolymer units, and end groups, the number of localized states and their distance can be controlled. The use of characterization tools such as TOF-SIMS can be used to examine these local nanostructures. Charge injection generally depends on the electron affinity of the polymer system. Low electron affinity polymers or states are preferred for hole injection and high electron affinity polymers or states are preferred for electron injection.

### Dopants

The CNT layer is modified by a dopant, doping moiety, or charge transfer agent. Semiconducting CNTs can be p-doped or n-doped by appropriate electron acceptors or donors, respectively, via charge transfer doping. Given that semiconducting CNTs constitute a large fraction of CNT structures, dopants offer a route for improving conductivity of individual CNTs. P-dopant additives could include, but are not limited to, perfluorosulfonic acids, thionyl chloride, organic pi-acids, nitrobenzene, organometallic Lewis acids, organic Lewis acids, or Bronsted acids. Materials that function as both dispersing agents and dopants such as Nafion. These materials contain p-doping moieties, i.e., electron accepting groups, within their structure, often as pendant groups on a backbone.

Preferred dopants include ionic liquids, such as those that are liquid at room temperature, such as salts derived from 1-methylimidazole and boron cluster ionics liquids, including 1-ethyl-3-methyl-(EMIM), 1-butyl-3-methyl-(BMIM), 1-octyl-3 methyl (OMIM), 1-decyl-3-methyl-(DMIM), 1-dodecyl-3-methyl-docecylMIM). Other imidazolium cations are 1-butyl-2,3-dimethylimidazolium (DBMIM), 1,3-di(N,N-dimethylaminoethyl)-2-methylimidazolium (DAMI), and 1-butyl-2,3-dimethylimidazolium (BMMIM) with BF4 or PF6. Isobutyl-monocarboranes are preferred over BF4 and PF6 for stability to off-gassing.

Other, nonlimiting, examples of doping agents include Bronsted acids, Lewis acids, and pi-acids⁻ and molecules with strong electron withdrawing groups such as CF₂SO₃H, CCl₂SO₃H, —NO₂, CN, —CF₃, —S(O)Cl, SO₂Me, NMe₃⁺, and N₂⁺. In some embodiments, the invention includes any combination of doping agents. Examples of the electron withdrawing groups are provided for the perfluoroalkyl sulfonic acid functional group and include: CF₂═CF—SO₃H; CF₂═CF—CF₂—SO₃H; CF₂═CF—SO₃H; CF₃—CF=CF—SO₃H; CF₃(CF₃)—CF—SO₃; R₂—O—CF₂CF₂—SO₃H; R₁—CF(R₂)—SO₃; R₁—C(R₁)═CF(R₁)—SO₃; where R₁ includes a halogen, any organic or polymer group including straight-chain or branched hydrocarbons (including alkanes, alkenes and alkynes), straight chain or branched fluorinated and perfluorinated alkanes, straight chain or branched chlorinated alkanes, aromatics and polycyclic aromatics, aliphatic and aromatic ethers, halogenated aromatics, and esters, and R₂ includes any of the above but excludes halogens. In some embodiments, the R group is a C₁ to C₂₀ alkane or alkene. Examples of other preferred dopant candidates include alkylsulfonic acid chlorides, such as: R₃—SO₂—Cl where e.g. R₃ is n-propyl [CAS number 10147-36-1] or n-octyl [7795-95-1] or their corresponding alkyl sulfonic acids products. Other preferred dopant candidates include sulfonic acid anhydrides such as: R₄—SO₂—O—SO₂—R₅; such as where R₄ and/or R₅ are —CH₃ [7143-01-3] or —CF3, respectively., or larger e.g. nonafluorobutane sulfonic anhydride [36913-91-4].

In some preferred embodiments, the dopant or dopant moiety is present in a range of 0.002 to 0.6 mol dopant or dopant moiety to gram CNT, and in some embodiments, 0.02 to 0.2 mol dopant or dopant moiety to gram CNT.

The dopants may be covalently bound to the storage later. An example is polymers containing a perfluoroalkyl sulfonic acid functional group are preferred in some embodiments, and in some preferred embodiments the dopants include one or more of the perfluoroalkyl sulfonic acid functional groups listed above. On the other hand, in some embodiments, the CNTs are not coated with dopants or polymers containing a perfluoroalkyl sulfonic acid functional group, in some embodiments, the CNTs are not coated with Nafion, and in some embodiments the CNT composite materials do not contain fluorine (in view of the persistence of fluorinated organics in the environment, it may be desirable to avoid such compounds). In some preferred embodiments, the doping agent has a molecular weight of 500 Daltons (also known as atomic mass units) or less, in some embodiments 300 or less (lower mass may provide some advantages such as enhanced mobility).

The presence of electron withdrawing compounds (p-dopants) such as, but not limited to, fluoralkyl-substituted sulfonic acids, benzonitrile, and nitrobenzene with high dipole moment can also act as charge transfer intermediates, accepting charge from the semiconducting CNTs and increasing the conductivity of the film.

A dopant-filled polymer coating may be prepared by blending a dopant or mixture of dopants with an appropriate polymer or mixture of polymers. In preferred embodiment, the polymer and dopant species are compatibilized using a third component. For example, the polymer may be dissolved in a solvent that is co-compatible with the dopant. Common useful solvents include aromatic hydrocarbons such as toluene or xylene, ether such as diethyl ether, tetrahydrofuran, or dioxane, polar aprotics such as dimethyl formamide or dimethylsulfoxide, halogenated hydrocarbons such as chloroform or methylene chloride, ketones such as acetone or methyl ethyl ketone, water, and alcohols, such as isopropanol. In another embodiment, the polymer is soluble in the dopant. In some embodiments, the dopant is a liquid or semi-solid at room temperature with a boiling point greater than 100° C., in some embodiments a boiling point greater than 120° C. (at standard conditions).

### Ground Plane/Conductive Layer

A conductive layer is disposed on a substrate. In the finished article, the conductive layer is in electrical contact with the dopant/electrolyte layer. The conductive layer can be a metal such as aluminum or can be another CNT layer. The conductive layer is typically disposed on a porous substrate such as a porous polymer or a porous ceramic. Articles were made with kiln paper (a flexible porous ceramic). For high temperature operation, a material should be selected that is stable at the desired operating temperature. In some applications, it is desirable to avoid materials such as aluminum which are easily detected by radar sensors.

### Articles Underlying The Tunable CNT Coating

In some preferred embodiments, the substrate upon which the CNT/storage layer composite is disposed is an article of clothing, other fabric such as a tent, a vehicle such as a truck or an airplane or part of a vehicle, a window, a structural component such as a wall. The geometric surface area (that is, the area that can be measured by a ruler rather than BET surface area) of the coated article is preferably at least 0.5 cm×0.5 cm, more preferably at least 1 cm×1 cm, in some embodiments at least 5 cm×5 cm.

### Protective Coating

A protective coating composition can be applied to the CNT network by known methods, for example, bar coating, spin coating, or spraying. Techniques, such as troweling, that disrupt the CNT network should be avoided. After application of a protective coating to the CNT network, the coated substrate can be cured (in some embodiments, curing is conducted at ambient temperature). In the curing operation, the film forming materials crosslink to leave a gas impermeable, mechanically durable and chemically resistant film.

A multilayered laminate resistive heater could be manufactured with conventional roll coat equipment. Electronic leads could be printed on a base substrate, such as 3M′s Aerospace quality protective film. The carbon nanotube dispersion can then be applied to the film printed with circuitry with conventional roll coating methods. The protective coating could also be applied in this manner in-line.

If the coating material is transparent in the near infrared (less than 5% absorbance), the thickness of an optional coating composition over the CNT material is preferably 2 mm or less, more preferably 150 μm or less, more preferably 50 μm or less, in some embodiments, a thickness of 250 nm to 50 μm; thicker layers can experience pin-hole type defect caused by foaming or bubbling during application that leads to pathways for a subsequent topcoat to penetrate and disrupt the conductivity of the CNT layer. If the coating material is not entirely transparent in the near infrared, the thickness of an optional coating composition over the CNT material is preferably 5 μm or less.

The aqueous or non-aqueous solvent present in common top coats, when applied to a CNT material, may disrupt the electrical properties of the CNT material by several mechanisms. One mechanism is by increasing the electrical resistance between adjacent CNTs. Topcoats dissolved in solvents can infiltrate the CNTs, permitting the topcoat resin system to permeate and cure between the individual CNT fibers. The CNTs require intimate contact to transport electrical charge from one CNT to another; charge transport takes place though either tunneling or hopping. If a non-conductive polymer resin remains between the CNTs, it can prevent close contact of CNTs, which increases the energy associated with electron hopping or tunneling and behaves as a high resistance resistor in series. The effect is that the bulk conductivity of the CNT material is reduced significantly. Treatment of CNTs with surfactants or dispersing agents is often used to improve their interaction with water or solvents. After film formation, these surfactants and dispersing agents often remain in the film, continuing to modify the surface properties of the CNTs. This renders the CNT layer more susceptible to penetration by aqueous or non-aqueous solvents. To avoid this problem, in some preferred embodiments, a solvent-free protective layer can be used to prevent the change in resistance that accompanies the application of either organic-solvent-based or water-based coatings to CNT materials. In some embodiments, a polyurethane coating is in direct contact with the CNT layer.

In some embodiments, solventless, preferably 100% solids, (free of organic and water solvent) suitable isocyanate compound or mixture of compounds can be used as the curing agent to form the protective layer. To function as an effective crosslinking agent, the isocyanate should have at least two reactive isocyanate groups. Suitable polyisocyanate crosslinking agents may contain aliphatically, cycloaliphatically, araliphatically and/or aromatically bound isocyanate groups. Mixtures of polyisocyanates are also suitable. Polyisocyanate conataining aliphatically, cycloaliphatically, araliphatically and/or aromatically bound polyisocyanate groups are also suitable. This includes, for example: hexamethylene trimethylhexamethylene diisocycante, meta-α,═,α′,α′-tetramethylxylylenediisocyanate, 1-isocyanato-3,3,5-trimethyl-5-isocyanatomethyl cyclohexane (isophoronoe diisocyanate or “IPDI”), bis(4-isocyanatocyclohexyl)methane (hydrogenate MDI), toluene diisocyanate (“TDI”), hexamethylene diisocyanate (“HDI”) or biuret derivatives of various diisocyanates.

A solventless coating composition comprises reactive components that react to form a solid coating; preferably the composition comprises a polyol and an isocynate. The polyol component of the present invention contains both (i) functionality capable of reacting with isocyanate groups (“isocyanate-reactive”) and (ii) 100% solids content (free from any organic or water solvent). The expression “isocyanate-reactive” functionality as used herein refers to the presence of functional groups that are reactive with isocyanate groups under conditions suitable for cured coating formation. Such isocyanate-reactive functionality is generally known to those skilled in the coatings are and includes, most commonly, active hydrogen-containing functionality such as hydroxyl and amino groups. Hydroxyl functionality is typically utilized as the isocyanate-reactive functionality in coatings and is essentially suitable for use in the present invention. In some embodiments, the polyol is a polyester polymer having isocyanate-reactive functionality incorporated into the polymer via appropriate monomer selection. Examples of monomers that may be utilized to synthesis the polyester polyol include carboxyl group-containing ethylenically unsaturated monomers and hydroxyl group-containing ethylenically unsaturated monomers.

In addition to the components discussed above, other additives can also be incorporated such as cure catalysts. Cure catalysts for isocyanate are well known to those skilled in the art such as organometallic catalysts and, particularly, organotin compounds such as dibutyltin diacetate, dibutyltin dioxide, bibutyltin dilaurate and the like. Other optional ingredients such as surfactants, defoamers, thixotropic agents, anti-gassing agents, flow control agents, pigments, fillers, and other additives without added organic or water solvents may be included in the composition. In preferred embodiments, the polymer precursor composition comprises at least 90 mass %, more preferably at least 95 mass % (in some embodiments at least 98 mass %) of components that, after curing, are bonded to the polymer structure.

Devices were constructed with protective films of polyethylene (7.5 μm thick) or polysilazane (10 μm thick). Polyethylene and polysilazane are preferred coating compositions because they are essentially transparent in the infrared and do not interfere with performance of adaptive emissivity technology. Both devices performed well. The coated articles exhibit enhanced stability to oxidation and moisture. These coatings are preferably 20 μm or less in thickness or 10 μm or less or in the range of 5 to 10 μm. For high temperature applications such as applied over rocket engines, the a high temperature polymer can be selected as the protective coating.

### Electronic Control

The assembled device is operated by charging the electrodes with a voltage source that can range from a lower limit of zero (or no charge) to an upper limit that is dependent on the construction of the device and the composition of the ionic liquid or dopant and the dielectric layer. An intermediate voltage will result in a different emissivity at the CNT surface and thus a different apparent temperature.

The charging process can be current limited to avoid damaging the device and can be accomplished by the use of a standard current-limiting laboratory power supply or other current limiting source. The device can also be controlled with the current-limiting output lines of a microcontroller or a digital to analog converter (DAC), allowing the user to dynamically control the apparent temperature or emissivity through a programmable interface or a graphical user interface.

An assembled device can be reset to its unpowered state by connecting both of its electrodes to ground. This process can take several minutes for a 10 cm by 15 cm device. Resetting the device state can also be more quickly achieved by reversing the voltage applied across the device's electrodes.

The emissivity range is provided by the properties of the CNTs and the effectiveness of the charge transfer interaction. It is possible for CNTs to have an emissivity of 0.95 or even more depending on the orientation and density. Random CNT networks typically have an emissivity of 0.4 to 0.6. This can be reduced by p-doping; for example, down to 0.1 to 0.4. For comparison, shiny aluminum foil has an emissivity of 0.03 and loses almost none of its heat through thermal radiation.

The lower emissivity of a device's surface can be caused by increasing the surface's reflectivity in the MWIR/LWIR, following Kirchhoff's Law. This is a dynamic effect that is influenced by, for example, changing the order of an ionic liquid at the surface through the accumulation of charge. Moving the surface further from a perfect blackbody, it radiates less energy and reflects the background better.

Given that the systems can be patterned, one can also operate it as an infrared (IR) display.

### EXAMPLE: 1

A polyethylene fabric was coated with a CNT dispersion. The PE fabric was impregnated with an ionic liquid and placed on an electrically conductive thin film such as aluminum or a polymer film sputtered with Al. When a voltage was applied between the Al surface and the CNT layer, the ionic liquid dopes the nanotubes and changes the emissivity of the CNT coating causing it to appear as a different temperature in an infrared camera (thermal imager). When placed on a 136° F. hot plate and voltage applied, the sample appears to be 80° F.

### EXAMPLE 2

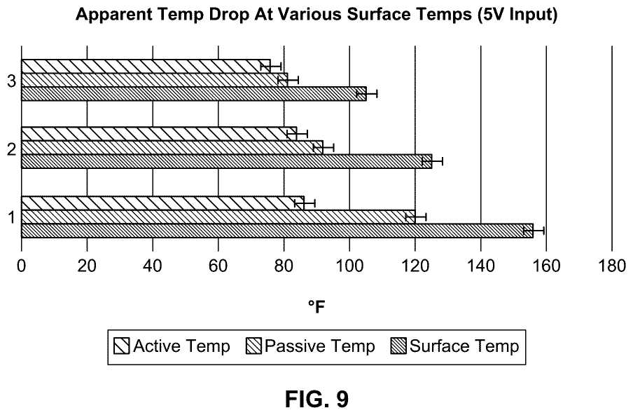

A polyethylene fabric was sputter coated to apply an aluminum electrode to one side. The other side was coated with a CNT dispersion. The PE fabric was then impregnated with an ionic liquid. When a voltage was applied between the aluminum (Al) surface and the CNT layer, the ionic liquid dopes the nanotubes and changes the emissivity of the CNT coating causing it to appear as a different temperature in an infrared camera (thermal imager). When placed on a 150° F. hot plate, the voltage applied changed the apparent temperature, as measured by the thermal camera. This is shown in FIG. 9. The higher the DC voltage applied, the lower the temperature appears due to the increased level of doped CNTs. For example, a passive effect of temperature change due to the inherent low emissivity of the CNT layer itself. So even without any voltage applied between the aluminum and CNT layers, the temperature appears as 110° F. At 1.5 applied volts, the temperature appears as 102° F., 3 volts appears as 94° F. and 4.5 volts applied appears as 9° F. The actual surface temperature of the fabrics is the same as the hot plate at 150° F., only the difference in emissivity accounts for the change in apparent temperature.

This drop in apparent temperature is also affected by the actual temperature of the surface. The closer the actual surface temperature is to ambient, the less dramatic the active apparent temperature drop will be.

### EXAMPLE #3

A polyethylene fabric was sputter coated to apply an aluminum electrode to one side. The other side was coated with a CNT dispersion having around 0.2 wt % CNTs. The PE fabric was impregnated with an ionic liquid. When a voltage was applied between the Al surface and the CNT layer, the ionic liquid dopes the semiconducting nanotubes and changes the emissivity of the CNT coating resulting it to appear as a different temperature in an infrared camera (thermal imager).

When placed on a 171° F. hot plate, voltage applied changed the apparent temperature, as measured by the thermal camera. For example, a passive effect of temperature changes due to the inherent low emissivity of the metallic SWCNT layer itself. So even without any voltage applied between the aluminum and SWCNT layers, the temperature appears as 144° F.

At 5 applied volts, the temperature appears as 118° F. The actual surface temperature of the fabrics is the same as the hot plate at 171° F., only the difference in emissivity accounts for the change in apparent temperature.

### EXAMPLE #4

The current collector was tape cased on one side of the Kiln paper. The use of Kiln paper instead of PE broadens device operation temperature beyond the melting temperature of PE because Kiln Paper's thermal stability is around 300° C. The other side was coated with a CNT dispersion. The assembly was impregnated with an ionic liquid. The change on emissivity when a voltage was applied between the Al surface and the CNT layer was observed due to doping effect of the ionic liquid onto the CNT.

When placed on a 171° F. hot plate, voltage applied changed the apparent temperature, as measured by the thermal camera. For example, a passive effect of temperature changes due to the inherent low emissivity of the metallic SWCNT layer itself. So even without any voltage applied between the aluminum and SWCNT layers, the temperature appears as 144° F.

At 5 applied volts, the temperature appears as 118° F. The actual surface temperature of the fabrics is the same as the hot plate at 171° F., only the difference in emissivity accounts for the change in apparent temperature.

### EXAMPLE #5

The device with a protective coating such as PE or Polysilazane (PSZ) can be applied onto the CNT network by known methods, for example, bar coating, spin coating, or spraying at the end of the process.

As described in previous example, the current collector layer was initially produced by sputtering technique on one side of the porous substrates (such as PE, Kiln papyrus, or gamma alumina layer). Then, the other side was coated with a CNT dispersion. The assembly was impregnated with an ionic liquid which would avoid potential disrupt the CNT network due to trolling phenomenon that might occur during the casting procedure of protective top layer. After application of a protective coating to the CNT network, the coated substrate is cured at ambient temperature. During this process, the film forming materials can be crosslinked to leave a gas impermeable, mechanically durable, and chemically resistant film.

The change on emissivity when a voltage was applied between the Al surface and the CNT layer was observed.

The PE was applied to the top surface through sealing a free solid film of solid 7.5 micrometer polyethylene using an iron to fuse it to the CNT surface. Since the PE film is very uniform in thickness, and free from pinholes—there isn't a problem with applying a consistent liquid coating onto a relatively rough substrate. The polysilazane was a low solids liquid applied with a drawdown bar, so more difficult to get an even coating. Durability and integrity of the samples with and without protective layers were tested in terms of their solvent resistance and adhesion by rubbing technique (ASTM D5402) and tape test technique (ASTM D3359), respectively. The results (see Table below) showed that the protective layer improves drastically its adhesion performance as well as integrity or its handling performance.

| | ASTM | ASTM D5402 | ASTM D3359 |
|---|---|---|---|
| | D5402 | Water - | Tape |
| Sample id | Dry rubs | wetrubs | Adhesion |
| Control - no topcoat | 2 | 1 | Fail |
| Polysilazanetopcoat - | 4 | 1 | Pass |
| drawbar #8 | | | |
| 7 micron | 25 | 45 | pass |
| Polyethylenetopcoat | | | |

What is claimed:

1. A thermal management or infrared display system comprising a device comprising, in sequence: a first electrode, a storage layer comprising a dopant, a CNT layer in contact with the storage layer; and a second electrode, wherein the CNT layer has two opposing, major surfaces wherein one major surface contacts the storage layer and the other major surface contacts the second electrode.

2. The thermal management or infrared display system of claim 1 comprising electrodes configured to pass a current through the CNTs in the plane of the CNT layer.

3. The thermal management or infrared display system of any of the above claims comprising a protective layer overlying and in direct contact with the CNT layer; wherein the protective layer comprises polyethylene, polypropylene, or polysilazane.

4. The thermal management or infrared display system of any of the above claims comprising a protective layer overlying and in direct contact with the CNT layer; wherein the protective layer has a thickness of 20 μm or less.

5. The thermal management or infrared display system of any of the above claims wherein the second electrode comprises a second CNT layer in direct contact with a porous ceramic layer; wherein the second CNT layer is in contact with a bus bar.

6. The thermal management or infrared display system of any of the above claims comprising a plurality of cells that are individually addressable.

7. The thermal management or infrared display system of any of the above claims wherein the dopant comprises an ionic liquid.

8. The thermal management or infrared display system of any of the above claims wherein the first electrode comprises a CNT layer.

9. The thermal management or infrared display system of any of the above claims wherein the storage layer has a thickness between 15 and 500 nm.

10. The thermal management or infrared display system of any of the above claims wherein the first electrode is disposed between a substrate and the storage layer; wherein the substrate comprises clothing, a tent, or a vehicle.

11. The thermal management or infrared display system of any of the above claims wherein the device is stable up to at least 300° C.

12. The thermal management or infrared display system of any of the above claims wherein the second electrode comprises an aluminum film.

13. The thermal management or infrared display system of any of the above claims wherein the second electrode covers at least 80% or at least 90% of the surface of the CNT layer.

14. The thermal management or infrared display system of any of the above claims wherein each of the components in the sequence form a cell; and further comprising a plurality of the cells that are independently addressable.

15. The thermal management or infrared display system of any of the above claims wherein the first electrode is disposed between a substrate and the storage layer; wherein the system has infrared emissivity tunability such that if the device is held at 60° C., or 65° C., or 80° C. and a voltage of 1 V or 3 V or 5 V is applied between the first and second electrodes, then the apparent surface temperature lowered by at least 10° C., or at least 20° C., or in the range of 10 to 40° C. or 10 to 30° C.

16. A thermal management or infrared display system comprising a device comprising, in sequence: a first electrode, a storage layer comprising a dopant, a CNT layer in contact with the storage layer; and a second electrode, wherein the storage layer comprises a woven or nonwoven fabric, porous ceramic, or gel.

17. The thermal management or infrared display system of claim 16 comprising electrodes configured to pass a current through the CNTs in the plane of the CNT layer.

18. The thermal management or infrared display system of any of the above claims comprising a protective layer overlying and in direct contact with the CNT layer; wherein the protective layer comprises polyethylene, polypropylene, or polysilazane.

19. The thermal management or infrared display system of any of the above claims comprising a protective layer overlying and in direct contact with the CNT layer; wherein the protective layer has a thickness of 20 μm or less.

20. The thermal management or infrared display system of any of the above claims comprising a plurality of cells that are individually addressable.

21. The thermal management or infrared display system of any of the above claims wherein the dopant comprises an ionic liquid.

22. The thermal management or infrared display system of any of the above claims wherein the first electrode comprises a CNT layer.

23. The thermal management or infrared display system of any of the above claims wherein the storage layer has a thickness between 15 and 500 nm.

24. The thermal management or infrared display system of any of the above claims wherein the first electrode is disposed between a substrate and the storage layer; wherein the substrate comprises clothing, a tent, or a vehicle.

25. The thermal management or infrared display system of any of the above claims wherein the device is stable up to at least 300° C.

26. A method of providing adaptive thermal management on a surface of a substrate, comprising:
providing a system comprising: the substrate; a storage layer comprising a dopant disposed on the substrate, a CNT layer in contact with the storage layer; a first electrode, and a second electrode; the electrodes contact the storage layer and/or CNT layer; and
applying a voltage to the electrodes that causes the mobile dopant to modify the emissivity of the CNT layer.

27. The method of claim 26 wherein the system comprises, in sequence, the first electrode, the storage layer comprising a dopant, the CNT layer in contact with the storage layer; and the second electrode, wherein the CNT layer has two opposing, major surfaces wherein one major surface contacts the storage layer and the other major surface contacts the second electrode.

28. The method of claim 27 wherein the substrate is at a temperature of at least 60° C., or at least 65° C., or at least 80° C., and applying a voltage of at least 1 V or at least 3 V or at least 5 V between the electrodes. Temperature of the surface can measured by conventional means such as the FLIR systems mentioned above.
